(19) United States
(12) Patent Application Publication
(10) Pub. No.: US 2015/0379030 A1
(43) Pub. Date: Dec. 31, 2015

(54) PLATFORM INTEGRATING METHOD AND SYSTEM FOR ADAPTING THIRD-PARTY WEB PAGE IN APPLICATION

(71) Applicant: Beijing Jinher Software Co.,Ltd, Beijing (CN)

(72) Inventor: Runfeng LUAN, Beijing (CN)

(21) Appl. No.: 14/332,406

(22) Filed: Jul. 16, 2014

(30) Foreign Application Priority Data
Jun. 27, 2014 (CN) 201410301840.1

(51) Int. Cl. G06F 17/30; H04L 29/08; G06F 3/0481

(52) U.S. Cl. CPC G06F 17/3089; G06F 17/30887; G06F 3/04817; H04L 67/02

(57) ABSTRACT

The invention discloses a platform integrating method for adapting a third-party web page in an application, comprising a first step of embedding a control for browsing the web page in a client of the application; a second step of establishing a correlation between the control and a custom module of an application generation platform; and a third step of receiving by a custom module a command input for adapting the third-party web page, thereby enabling the client to access the third-party web page by using the control. The invention further discloses a platform integrating system for adapting a third-party web page in an application, comprising: a client, in which a control for browsing the web page and an application are embedded; an application generation platform, which is used for generating an application, and in which a custom module correlated with the control is provided.

### CROSS-REFERENCE TO RELATED APPLICATION

This application claims the priority benefit of Chinese patent application No. 201410301840.1, filed on Jun. 27, 2014. The entirety of the above-mentioned application is hereby incorporated by reference herein and made a part of specification.

### BACKGROUND OF THE INVENTION

1. Field of the Invention

The invention relates to a platform integrating method and system for adapting a third-party web page in an application.

2. Background of the Invention

Nowadays, the applications (also referred to as Apps) on the mobile terminals generally are developed and configured by a developer. A user gets the application by paying or for free, and then installs the application on his own mobile terminal. Beijing Jinhe Software Co., Ltd. has developed an App self-service factory, i.e., Jinhe IU, which is a free application producing platform. The user can produce his own App on Jinhe IU, and downloads the App to his mobile terminal. In addition, in the App produced via Jinhe IU, the user can configure the customized content at his preference.

### BRIEF SUMMARY OF THE INVENTION

It is an object of the invention to provide a platform integrating method for adapting a third-party web page in an application.

It is another object of the invention to provide a platform integrating system for adapting a third-party web page in an application.

According to the method and system of the invention, the user can configure, add, or delete the third-party web page in the application at his preference, or modify positions among plug-ins, name or the like, thus configuring an App which fits for himself.

The technical solutions of the invention provide lie in the following aspects.

A platform integrating method for adapting a third-party web page in an application comprises:

a first step of embedding a control for browsing the web page in a client of the application;

a second step of establishing a correlation between the control and a custom module of the application generation platform; and

a third step of receiving by the custom module a command input that adapts the third-party web page, thereby enabling the client to access the third-party web page by using the control.

Preferably, in the platform integrating method of the invention, the application is applicable to an IOS system and an Android system.

Preferably, in the platform integrating method of the invention, in the third step, at least one custom plug-in is provided in the custom module, wherein the custom plug-in is used for receiving from the user the command input that adapts the third-party web page.

Preferably, in the platform integrating method of the invention, in the third step, after receiving by the custom plug-in from the user the command input that adapts the third-party web page, a JSON file is generated by the application generation platform from the content of the command input,

when a MAC service receives the JSON file, replaces relevant data in the PLIST configuration file in the application custom module with a packaging service program, saves and generates a new application, the new application is applicable to the IOS system, and

once the user downloads and installs the new application, respective plug-in can be loaded, and the adaptive third-party web page can be opened with the control.

Preferably, in the platform integrating method of the invention, in the third step, after receiving by the custom plug-in from the user the command input that adapts the third-party web page, a JSON file is generated by the application generation platform from the content of the command input,

when a Windows service receive the JSON file, replaces relevant data in the XML configuration file in the application custom module with a the packaging service program, saves and generates a new application, the new application is applicable to the Android system, and

once the user downloads and installs the new application, respective plug-in can be loaded, and the adaptive third-party web page can be opened with the control.

Preferably, in the platform integrating method of the invention, the at least one custom plug-in comprises a plurality of custom plug-ins, and in case that the custom module has a plurality of custom plug-ins, the plurality of custom plug-ins comprise a first custom plug-in and at least one second custom plug-in, wherein the first custom plug-in receives a command input for modifying name and order, and the second custom plug-in receives a command input for modifying name, icon, and address and order.

Preferably, in the platform integrating method of the invention, the address is a URL (Uniform Resource Locator).

Preferably, in the platform integrating method of the invention, the icon of the second custom plug-in is correlated with the address, and the user accesses the third-party web page which is directed by the URL by clicking the icon.

A platform integrating system for adapting a third-party web page in an application comprises:

a client, in which a control for browsing the web page and an application are embedded;

an application generation platform, which is used for generating the application, and in which a custom module is provided, wherein the custom module is correlated with the control; and

a system for causing the custom module to receive a command input that adapts the third-party web page, thereby enabling the client to access the third-party web page by using the control.

Preferably, in the platform integrating system of the invention, the application is applicable to an IOS system and an Android system.

Preferably, the platform integrating system of the invention further comprises:

a system for configuring at least one custom plug-in in the custom module; and

a system for causing the custom plug-in to receive a command input from the user that adapts the third-party web page.

Preferably, the platform integrating system of the invention further comprises: after the custom plug-in receives from the user the command input that adapts the third-party web page,

the application generation platform is provided with a system for generating a JSON file according to the content of the command input;

a packaging service system;

a MAC system, which is used for receiving the JSON file, and which replaces relevant data in the PLIST configuration file in the application custom module with the packaging service system; and

a system for saving and generating a new application which is applicable to the IOS system.

Preferably, the platform integrating system of the invention further comprises: after the custom plug-in receives from the user the command input that adapts the third-party web page, the application generation platform is provided with a system for generating a JSON file according to the content of the command input;

a packaging service system;

a Windows service, which is used for receiving the JSON file, and which replaces relevant data in a XML configuration file in the application custom module with the packaging service system; and

a system for saving and generating a new application which is applicable to Android system.

Preferably, in the platform integrating system of the invention, the at least one custom plug-in comprises a plurality of custom plug-ins, and in case that the custom module has a plurality of custom plug-ins, the plurality of custom plug-ins comprise a first custom plug-in and at least one second custom plug-in,

the system for causing the custom plug-in to receive the command input from the user that adapts the third-party web page comprises:

a system for causing the first custom plug-in to receive a command input for modifying name and order; and

a system for causing the second custom plug-in to receive a command input for modifying name, icon, and address and order.

Preferably, in the platform integrating system of the invention, the address is a URL.

Preferably, in the platform integrating system of the invention, the icon of the second custom plug-in is correlated with the address, and the user accesses the third-party web page which is directed by the URL by clicking the icon.

In the application generation platform of the invention, the user is allowed to design and generate an application at his preference. According to the method and system of the invention, in the custom module the user can adapt the third-party web page or adjust the orders among plug-ins, or modify the name of the plug-in into his favorite name. In this manner, even a user knows nothing about producing an application at background, he can still produce an application that fits to himself and thus can produce his own App.

### BRIEF DESCRIPTION OF THE DRAWINGS

FIG. 1 is a flowchart illustrating a platform integrating method for adapting a third-party web page in a network switch application of the invention; and

FIG. 2 illustrates a portion of a PLIST numeric file in MAC service of the invention.

### DETAILED DESCRIPTION OF THE EMBODIMENTS

The invention will be described in detail hereinafter by referring to its embodiments, so that the skilled in the art can implement the invention in accordance with the present disclosure.

A platform integrating method for adapting a third-party web page in an application comprises:

a first step of embedding a control, i.e., a webview control, for browsing the web page in a client of the application;

a second step of establishing a correlation between the control and a custom module of an application generation platform; and

a third step of providing at least one custom plug-in in the custom module. Generally, a plurality of custom plug-ins is provided. For example, there are four custom plug-ins, i.e., three first custom plug-ins and a second custom plug-in. The first custom plug-ins receive a command input for modifying name and order, and the second custom plug-in receives a command input for modifying name, icon, and address and order. In the second custom plug-in, the input address is a URL. The URL is directed at the third-party web page to which it is linked. The icon of the second custom plug-in is correlated with the address. By clicking the icon, the user can access the third-party web page which is directed by the URL.

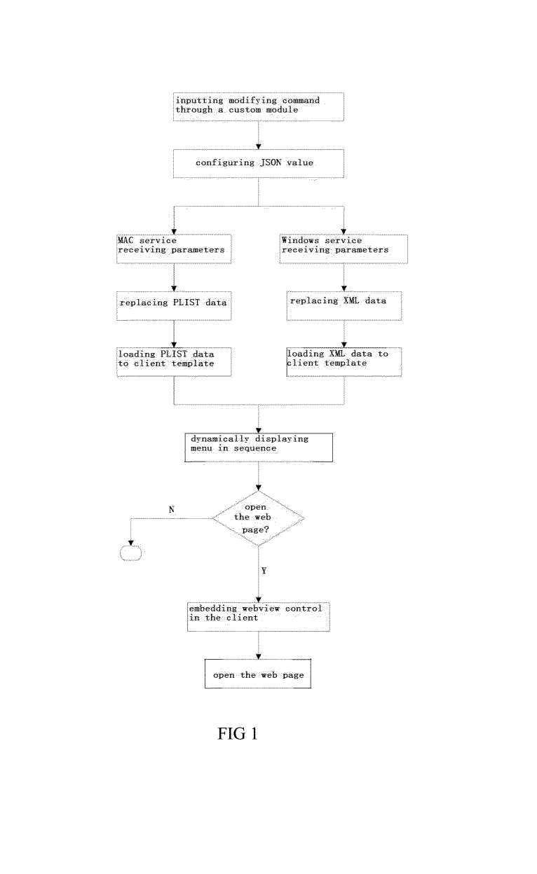

As shown in FIG. 1, after the custom plug-in receives from the user a command input that adapts the third-party web page, the user inputs contents to be changed through the custom plug-in, which comprise modifying name of the plug-in, adjusting orders of plug-ins, and adding a new functional plug-in through the second custom plug-in. When the user adds a new functional plug-in through the second custom plug-in, he can configure the name of the functional plug-in, select the icon for the functional plug-in, and input a hyperlink address.

The application generation platform generates a JSON file according to the content of the command input, as indicated hereinafter:

[

{

“name”: “Homepage”,
“type”: “home”,
“value”: “http://www.baidu.com”,
“icon”: 0

},
{

“name”: “Custom”,
“type”: “custom”,
“value”: “http://www.sina.com”,
“icon”: 0

},
{

“name”: “Gold coin”,
“type”: “gold”,
“value”: “http://www.163.com”,
“icon”: 0

},
{

“name”: “Break news”,
“type”: “brokenews”,
“value”: “http://www.qq.com”,
“icon”: 0

},
{

“name”: “More”,
“type”: “more”,
“value”: “http://www.google.com”,
“icon”: 0

}

]

Then, the generated JSON file is transferred to MAC service and Windows service, respectively.

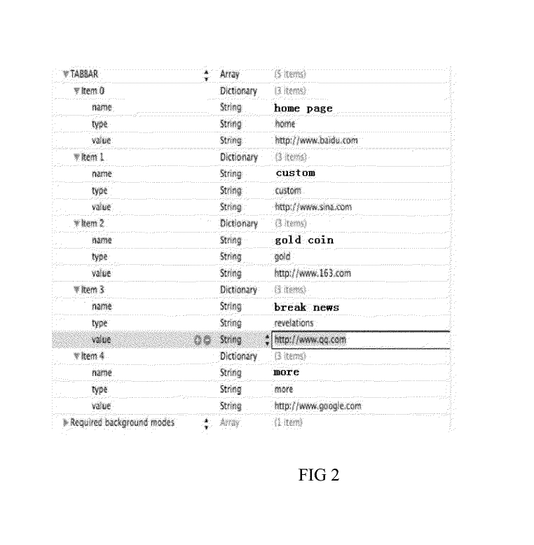

Upon receiving the JSON file, the MAC service replaces relevant data in the PLIST configuration file in the application custom module with a packaging service program, as shown in FIG. 2, where the hatched area indicates the data to be modified.

When a new application is saved and generated, the new application is applicable to the IOS system.

Once the user in the IOS system downloads and installs the new application, the respective plug-in can be loaded, so that the user can access the adapted third-party web page by using the webview control.

The custom module receives a command input that adapts the third-party web page, thereby enabling the client to access the third-party web page by using the control.

Upon receiving the JSON file, the Windows service replaces relevant data in the XML configuration file in the application custom module with the packaging service program. When a new application is saved and generated, the new application is applicable to Android system.

Once the user in the Android system downloads and installs the new application, the respective plug-in can be loaded, so that the user can access the adapted third-party web page by using the webview control.

Furthermore, the application generation platform is provided with a mobile phone display interface, on which the modifications configured by the user in the custom module can be displayed in real time, so that the user can view the modification effects. For example, when the user adds or deletes a functional plug-in through the second custom plug-in, adding or deleting the functional plug-in is displayed in real time on the mobile phone display interface. In another example, when the user modifies the name, icon, or function link of the custom plug-in, or modifies orders among plug-ins, all of such modifications can be displayed in real time on the mobile phone display interface, thus enabling the user to view his modification effects. In this manner, the time for the user to modify the custom module can be saved. It is possible to solve the problem of configuring the application to obtain the desired effects by installing and uninstalling the application repeatedly, thus saving time for the user.

Of course, apart from the custom plug-in, the custom module is further provided with common plug-ins that the user can not change, or other programs.

The custom module is independently arranged with respect to the primary application which generates an application in the application generation platform, and is connected with the primary application.

A platform integrating system for adapting a third-party web page in an application comprises:

a client, in which a control for browsing the web page and an application are embedded;

an application generation platform, which is used for generating the application, and in which a custom module is provided, wherein the custom module is correlated with the control; and

a system for configuring at least one custom plug-in in the custom module; and

a system for causing the custom plug-in to receive a command input from the user that adapts the third-party web page,

wherein the at least one custom plug-in comprises a plurality of custom plug-ins, and in case that the custom module has a plurality of custom plug-ins, the plurality of custom plug-ins comprise a first custom plug-in and at least one second custom plug-in.

The system for causing the custom plug-in to receive the command input from the user that adapts the third-party web page comprises:

a system for causing the first custom plug-in to receive a command input for modifying name and order; and

a system for causing the second custom plug-in to receive a command input for modifying name, icon, and address and order. The address input in the second custom plug-in is a URL, which is directed to the third-party web page, and the icon of the second custom plug-in is correlated with the address, so that the user can access the third-party web page which is directed by the URL by clicking the icon.

The system of the invention further comprises:

after the user inputs a command through the custom plug-in,

the application generation platform is provided with a system for generating a JSON file according to the content of the command input, generates a JSON file according to the content of the input command, and transfers the generated JSON file to MAC service and Windows service, respectively.

a packaging service system;

a MAC system, which is used for receiving the JSON file, and which replaces relevant data in the PLIST configuration file in the application custom module with the packaging service system;

a system for saving and generating a new application which is applicable to the IOS system, which is used for saving the replaced PLIST data and generating an new application for the IOS system.

A system for enabling the client to access the third-party web page with the control, when the user in the IOS system downloads and installs the new application. Thus, the third-party web page can be opened.

WINDOWS service, which is used for receiving JSON file, and which replaces relevant data in a XML configuration file in the application custom module with the packaging service system;

A system for saving and generating a new application which is applicable to Android system, which is used for saving the replaced relevant data in the XML configuration file and generating a new application which is applicable to Android system.

A system for enabling the client to access the third-party web page with the control, when the user in the Android system downloads and installs the new application. Thus, the third-party web page can be opened.

Although the invention has been described above with reference to specific embodiments, it should be understood that the limitations of the described embodiments are merely for illustrative purpose and by no means limiting. Instead, the scope of the invention is defined by the appended claims rather than by the description, and all variations that fall within the range of the claims are intended to be embraced therein. Thus, other embodiments than the specific ones described above are equally possible within the scope of these appended claims.

What is claimed is:

1. A platform integrating method for adapting a third-party web page in an application, characterized by comprising:
a first step of embedding a control for browsing the web page in a client of the application;
a second step of establishing a correlation between the control and a custom module of an application generation platform; and
a third step of receiving by the custom module a command input that adapts the third-party web page, thereby enabling the client to access the third-party web page by using the control.

2. The method of claim 1, characterized in that, the application is applicable to an IOS system and an Android system.

3. The method of claim 2, characterized in that, in the third step, providing at least one custom plug-in in the custom module, wherein the custom plug-in is used for receiving from the user the command input that adapts the third-party web page.

4. The method of claim 3, characterized in that, in the third step, after receiving by the custom plug-in from the user the command input that adapts the third-party web page, generating a JSON file by the application generation platform from the content of the command input,
when a MAC service receives the JSON file, replaces relevant data in the PLIST configuration file in the application custom module with a packaging service program, saves and generates a new application, the new application is applicable to the IOS system, and
once the user downloads and installs the new application, respective plug-in can be loaded, and the adaptive third-party web page can be opened with the control.

5. The method of claim 3, characterized in that, in the third step, after receiving by the custom plug-in from the user the command input that adapts the third-party web page, generating a JSON file by the application generation platform from the content of the command input,
when a Windows service receive the JSON file, replaces relevant data in the XML configuration file in the application custom module with a the packaging service program, saves and generates a new application, the new application is applicable to the Android system, and
once the user downloads and installs the new application, respective plug-in can be loaded, and the adaptive third-party web page can be opened with the control.

6. The method of claim 3, characterized in that, the at least one custom plug-in comprises a plurality of custom plug-ins, and in case that the custom module has a plurality of custom plug-ins, the plurality of custom plug-ins comprise a first custom plug-in and at least one second custom plug-in, wherein the first custom plug-in receives a command input for modifying name and order, and the second custom plug-in receives a command input for modifying name, icon, and address and order.

7. The method of claim 6, characterized in that, the address is a URL.

8. The method of claim 7, characterized in that, the icon of the second custom plug-in is correlated with the address, and the user accesses the third-party web page which is directed by the URL by clicking the icon.

9. A platform integrating system for adapting a third-party web page in an application, characterized by comprising:
a client, in which a control for browsing the web page and an application are embedded;
an application generation platform, which is used for generating the application, and in which a custom module is provided, wherein the custom module is correlated with the control; and
a system for causing the custom module to receive a command input that adapts the third-party web page, thereby enabling the client to access the third-party web page with the control.

10. The system of claim 9, characterized in that, the application is applicable to an IOS system and an Android system.

11. The system of claim 10, characterized by further comprising:
a system for configuring at least one custom plug-in in the custom module; and
a system for causing the custom plug-in to receive a command input from the user that adapts the third-party web page.

12. The system of claim 11, characterized by further comprising: after the custom plug-in receives from the user the command input that adapts the third-party web page,
the application generation platform is provided with a system for generating a JSON file according to the content of the command input;
a packaging service system;
a MAC system, which is used for receiving the JSON file, and which replaces relevant data in the PLIST configuration file in the application custom module with the packaging service system; and
a system for saving and generating a new application which is applicable to the IOS system.

13. The system of claim 11, characterized by further comprising: after the custom plug-in receives from the user the command input that adapts the third-party web page,
the application generation platform is provided with a system for generating a JSON file according to the content of the command input;
a packaging service system;
a Windows service, which is used for receiving the JSON file, and which replaces relevant data in a XML configuration file in the application custom module with the packaging service system; and
a system for saving and generating a new application which is applicable to Android system.

14. The system of claim 11, characterized in that, the at least one custom plug-in comprises a plurality of custom plug-ins, and in case that the custom module has a plurality of custom plug-ins, the plurality of custom plug-ins comprise a first custom plug-in and at least one second custom plug-in,
the system for causing the custom plug-in to receive the command input from the user that adapts the third-party web page comprises:
a system for causing the first custom plug-in to receive a command input for modifying name and order; and
a system for causing the second custom plug-in to receive a command input for modifying name, icon, and address and order.

15. The system of claim 14, characterized in that, the address is a URL.

16. The system of claim 15, characterized in that, the icon of the second custom plug-in is correlated with the address, and the user accesses the third-party web page which is directed by the URL by clicking the icon.
